(19) United States
(12) Patent Application Publication
(10) Pub. No.: US 2008/0188623 A1
(43) Pub. Date: Aug. 7, 2008

(54) Tap-mediated, rheology-modified polymers and preparation methods

(75) Inventors: Bharat I. Chaudhary, Princeton, NJ (US); Malcolm F. Finlayson, Houston, TX (US); Stephen F. Hahn, Midland, MI (US); Stephane Costeux, Midland, MI (US); John Scott Parent, Kingston (CA); Saurav S. Sengupta, Kingston (CA)

Correspondence Address: The Dow Chemical Company, Intellectual Property Section, P.O. Box 1967, Midland, MI, 48641-1967, US

(73) Assignees: Dow Global Technologies Inc., Midland, MI (US); Queen's University at Kingston, Kingston (CA)

(21) Appl. No.: 11/592,524

(22) Filed: Nov. 3, 2006

Related U.S. Application Data
(60) Provisional application No. 60/733,542, filed on Nov. 4, 2005.

(51) Int. Cl. C08F 8/40

(52) U.S. Cl. 525/340

(57) ABSTRACT

The present invention yields a triallyl phosphate (TAP)-mediated, rheology-modified polymer being prepared in a reaction from a reaction mixture made from or containing (a) a free-radical, chain-scissionable organic polymer and (b) TAP, wherein the TAP-mediated, rheology-modified polymer has extensional viscosity at Hencky strains above one greater than that of the free-radical, chain-scissionable organic polymer and/or a Relaxation Spectra Index (RSI) greater than that of the free-radical, chain-scissionable organic polymer.

### FIELD OF THE INVENTION

This invention relates to polymer systems that undergo free radical reactions, wherein modifying the rheology of a chain-scissionable polymer is desirable.

### DESCRIPTION OF THE PRIOR ART

It is important to control the rheological properties of molten polymers when fabricating articles. In many cases, coupling the polymer chains is necessary to increase the melt strength and render the polymer useful for preparing the desired articles.

Free-radical coupling through the use of peroxides and radiation is conventionally used to couple polymers. Unfortunately, these approaches are largely ineffective with polymers that undergo the competing reactions of coupling and chain scissioning. There is a need to promote the beneficial coupling reaction while minimizing the impact of the detrimental chain-scissioning reaction.

Notably, attempts are frequently made to modify the rheology of polymers using nonselective free-radical chemistries. However, free-radical reactions at elevated temperatures can degrade the molecular weight of polymers containing tertiary hydrogens such as polypropylene and polystyrene.

To mitigate the free-radical degradation of polypropylene, the use of peroxides and pentaerythritol triacrylate is reported by Wang et al., in Journal of Applied Polymer Science, Vol. 61, 1395-1404 (1996). They teach that branching of isotactic polypropylene can be realized by free radical grafting of di- and tri-vinyl compounds onto polypropylene. However, this approach does not work well in actual practice as the higher rate of chain scission tends to dominate the limited amount of chain coupling that takes place.

Chain scission results in lower molecular weight and higher melt flow rate than would be observed were the chain coupling not accompanied by scission. Because scission is not uniform, molecular weight distribution increases as lower molecular weight polymer chains referred to in the art as “tails” are formed.

Another approach to producing rheology-modified polymers is described in U.S. Pat. Nos. 3,058,944; 3,336,268; and 3,530,108—the reaction of certain poly(sulfonyl azide) compounds with isotactic polypropylene or other polyolefins by nitrene insertion into C—H bonds. The product reported in U.S. Pat. No. 3,058,944 is crosslinked. The product reported in U.S. Pat. No. 3,530,108 is foamed and cured with a cycloalkane-di(sulfonyl azide). In U.S. Pat. No. 3,336,268, the resulting reaction products are referred to as “bridged polymers” because polymer chains are “bridged” with sulfonamide bridges.

Additionally and for example, efforts have been made to use coagents containing two or more terminal carbon-carbon double bonds or triple bonds with free-radical generation to improve melt extensional properties of polypropylene. Unfortunately, the most well established coagents are acrylates or methacrylates, which tend to undergo homopolymerization and thereby result in ineffective coupling.

Others have used free radical reactions in the presence of coagents to overcome degradation of a chain scissionable polymer and yield a substantially crosslinked polymer. Those crosslinked polymers are not melt processable as defined herein; furthermore, the crosslinked polymers possess weight percent gel in amount rendering the polymers unsuitable for use in the presently-described applications. See DE 3133183 A1.

It is desirable to increase the melt viscosity and melt strength of various polymers by coupling the polymer to offset the extent of chain scission.

It is desirable to yield a rheology-modified polymer with low level of gels and excellent clarity. It is also desirable to control the molecular architecture of the polymer as it undergoes the coupling reaction.

It is desirable to yield a coupled polymer that is particularly useful in processes where melt strength is important such as extrusion foaming and blow molding.

It is further desirable to provide a process for preparing TAP-mediated, rheology-modified polymers from free-radical, chain-scissionable organic polymers.

### SUMMARY OF THE INVENTION

In its preferred embodiment, the present invention yields a TAP-mediated, rheology-modified polymer being prepared in a reaction from a reaction mixture comprising (a) a free-radical, chain-scissionable organic polymer and (b) triallyl phosphate (TAP), wherein the TAP-mediated, rheology-modified polymer has an extensional viscosity at Hencky strains above one greater than that of the free-radical, chain-scissionable organic polymer and/or a Relaxation Spectra Index (RSI) greater than that of the free-radical, chain-scissionable organic polymer.

The present invention is useful in wire-and-cable, footwear, film (e.g. greenhouse, shrink, and elastic), engineering thermoplastic, highly-filled, flame retardant, reactive compounding, thermoplastic elastomer, thermoplastic vulcanizate, automotive, vulcanized rubber replacement, construction, furniture, foam, wetting, adhesive, paintable substrate, dyeable polyolefin, moisture-cure, nanocomposite, compatibilizing, wax, calendared sheet, medical, dispersion, coextrusion, cement/plastic reinforcement, food packaging, non-woven, paper-modification, multilayer container, sporting good, oriented structure, and surface treatment applications.

The invention further provides a process for making a TAP-mediated, rheology-modified polymer which is exemplified below.

In a preferred embodiment, the present invention is an article of manufacture prepared from the rheology-modifiable polymer composition.

### BRIEF DESCRIPTION OF DRAWING

FIGS. 1 and 2 show the effect of an organic peroxide and various coagents on Shear-Thinning for a Polypropylene resin.

FIGS. 3 and 4 show the effect of an organic peroxide and various coagents on Creep Compliance for a Polypropylene resin.

FIGS. 5 and 6 show the effect of an organic peroxide and various coagents on Relative Recoverable Creep Compliance for a Polypropylene resin.

FIGS. 7 and 8 show the effect of an organic peroxide and various coagents on Normalized Shear-Thinning for a Polypropylene resin.

FIGS. 9-12 show the effect of an organic peroxide and various coagents on extensional viscosity of a polypropylene resin.

### DESCRIPTION OF THE INVENTION

“Constrained geometry catalyst catalyzed polymer”, “CGC-catalyzed polymer” or similar term, as used herein, means any polymer that is made in the presence of a constrained geometry catalyst. “Constrained geometry catalyst” or “CGC,” as used herein, has the same meaning as this term is defined and described in U.S. Pat. Nos. 5,272,236 and 5,278,272.

“Gel Number,” as used herein, means the average number of gels per square meter of evaluated polymeric composition as measured by extruding the polymer through a film die and using a Film Scanning System (FS-3) from Optical Counter System (OCS). “GN-300,” as used herein, means the average number of gels per square meter having a particle size of at least 300 micrometers. GN-300 would represent the total number of gels for 300-1600 micrometer measurements. “GN-600,” as used herein, means the average number of gels per square meter having a particle size of at least 600 micrometers. GN-600 would represent the total number of gels for 600-1600 micrometer measurements.

“Hencky Strain,” as used herein and sometimes referred to as true strain, is a measure of elongational deformation that applies to both polymer melts and solids. Elongational viscosity was measured at 180° C. on a Sentmanat Extensional Rheometer (SER) fixture (Xpansion Instruments, Tallmadge, Ohio (USA)) at Hencky strain rates of 1 sec⁻¹ and 10 sec⁻¹. If an end-separation device such as an Instron tester is used, the Hencky strain can be calculated as ln(L(t)/L₀), where L₀ is the initial length and L(t) the length at time t. The Hencky strain rate is then defined as 1/L(t)·dL(t)/dt, and is constant only if the length of the sample is increased exponentially.

On the other hand, using the SER, an elongational device with constant gauge length based on the dual wind-up device of Sentmanat (U.S. Pat. No. 6,691,569), a constant Hencky strain rate is simply obtained by setting a constant winding speed. The SER fits inside the environmental chamber of an ARES rheometer (TA Instruments, New Castle, Del. (USA)), in which the temperature is controlled by a flow of hot nitrogen.

The elongational viscosity (or uniaxial stress growth coefficient), ηE, is obtained by dividing the stress by the Hencky strain rate.

“Homogeneously Coupled,” as used herein, refers to the range of molecular weight over which branching is present as shown by a Mark-Houwink plot resulting from gel permeation chromatography (“GPC”) analysis. A broader range indicates more homogeneous coupling.

“Long Chain Branching (LCB),” as used herein, means, for example, with ethylene/alpha-olefin copolymers, a chain length longer than the short chain branch that results from the incorporation of the alpha-olefin(s) into the polymer backbone. Each long chain branch has the same comonomer distribution as the polymer backbone and can be as long as the polymer backbone to which it is attached.

“Melt Processable,” as used herein, means the polymer after being rheologically-modified continues exhibiting a thermoplastic behavior as characterized by the polymer being able to undergo melting and to flow in a viscous manner such that the polymer could be processed in conventional processing equipment such as extruders and shaping dies.

Melt flow rate was measured in accordance with ASTM 1238 at a temperature of 230° C. and load of 2.16 kg.

“Melt Strength,” as used herein, means the maximum tensile force at break or at the onset of draw resonance. Melt strength is measured according to the Rheotens (Goettfert Inc., Rock Hill, S.C., US) melt strength method. It consists of extruding a molten strand of polymer at a constant output rate using either a capillary rheometer or an extruder and drawing the strand down between a set of wheels. The wheels are rotated at a constant acceleration, producing a drawing velocity which increases linearly with time. During this process, the tension force of the strand acting on the wheels is recorded. Rheotens melt strength experiments are carried out at 190° C. The melt was produced by a Göttfert Rheotester 2000 capillary rheometer equipped with a flat, 30 mm long/2 mm diameter die at a shear rate of 38.2 sec⁻¹. The barrel of the rheometer (12 mm diameter) is filled in less than one minute, and a delay of 10 minutes is allowed for proper melting. The take-up speed of the Rheotens wheels was varied with a constant acceleration of 2.4 mm/sec². The tension in the drawn strand is monitored with time until the strand breaks. The steady-state force, in units of centiNewtons (cN) and the velocity at break (in mm/s), also called “drawability”, are reported.

“Drawdown stability,” as used herein, means the critical velocity at which web or bubble oscillation is likely to occur. “Draw resonance,” as used herein, means a sustained periodic oscillation in the cross-sectional area of the molten polymer film or strand.

“Metallocene,” as used herein, means a metal-containing compound having at least one substituted or unsubstituted cyclopentadienyl group bound to the metal. “Metallocene-catalyzed polymer” or similar term means any polymer that is made in the presence of a metallocene catalyst.

“Normalized Recoverable Creep Compliance,” as used herein, means creep compliance, Jc, normalized to its value at 1000 seconds. Creep is determined using a Reologica ViscoTech controlled stress rheometer equipped with 20 mm diameter parallel plates at 180 degrees Celsius (with 10 Pa load, unless otherwise indicated). The resulting rheology-modified polymer will preferably have a normalized recoverable creep compliance less than 0.90, more preferably less than 0.85, and most preferably less than 0.80.

“Polydispersity”, “molecular weight distribution”, and similar terms, as used herein, mean a ratio (M_{w}/Mₙ) of weight average molecular weight (M_{w}) to number average molecular weight (Mₙ).

“Polymer,” as used herein, means a macromolecular compound prepared by polymerizing monomers of the same or different type. “Polymer” includes homopolymers, copolymers, terpolymers, interpolymers, and so on. The term “interpolymer” means a polymer prepared by the polymerization of at least two types of monomers or comonomers. It includes, but is not limited to, copolymers (which usually refers to polymers prepared from two different types of monomers or comonomers, although it is often used interchangeably with “interpolymer” to refer to polymers made from three or more different types of monomers or comonomers), terpolymers (which usually refers to polymers prepared from three different types of monomers or comonomers), tetrapolymers (which usually refers to polymers prepared from four different types of monomers or comonomers), and the like. The terms “monomer” or “comonomer” are used interchangeably, and they refer to any compound with a polymerizable moiety which is added to a reactor in order to produce a polymer. In those instances in which a polymer is described as comprising one or more monomers, e.g., a polymer comprising propylene and ethylene, the polymer, of course, comprises units derived from the monomers, e.g., —CH₂—CH₂—, and not the monomer itself, e.g., CH₂═CH₂.

“P/E* copolymer” and similar terms, as used herein, mean a propylene/unsaturated comonomer (e.g. ethylene) copolymer characterized as having at least one of the following properties: (i) ¹³C NMR peaks corresponding to a regio-error at about 14.6 and about 15.7 ppm, the peaks of about equal intensity and (ii) a differential scanning calorimetry (DSC) curve with a Tₘₑ that remains essentially the same and a Tₚₑₐₖ that decreases as the amount of comonomer, i.e., the units derived from ethylene and/or the unsaturated comonomer(s), in the copolymer is increased. “Tₘₑ” means the temperature at which the melting ends. “Tₚₑₐₖ” means the peak melting temperature. Typically, the copolymers of this embodiment are characterized by both of these properties. Each of these properties and their respective measurements are described in detail in U.S. patent application Ser. No. 10/139,786, filed May 5, 2002 (WO2003040442) which is incorporated herein by reference.

These copolymers can be further characterized as also having a skewness index, Sᵢₓ, greater than about −1.20. The skewness index is calculated from data obtained from temperature-rising elution fractionation (TREF). The data is expressed as a normalized plot of weight fraction as a function of elution temperature. The molar content of isotactic propylene units primarily determines the elution temperature.

A prominent characteristic of the shape of the curve is the tailing at lower elution temperature compared to the sharpness or steepness of the curve at higher elution temperatures. A statistic that reflects this type of asymmetry is skewness. Equation 1 mathematically represents the skewness index, Sᵢₓ, as a measure of this asymmetry.

$${S}_{ix} \frac{\sqrt[3]{\sum {{w}_{i} ( {T}_{i} - {T}_{Max} )}^{3}}}{\sqrt{\sum {{w}_{i} ( {T}_{i} - {T}_{Max} )}^{2}}} . \qquad Equation 1$$

The value, Tₘₐₓ, is defined as the temperature of the largest weight fraction eluting between 50 and 90 degrees Celsius in the TREF curve. Tᵢ and wᵢ are the elution temperature and weight fraction respectively of an arbitrary, i^{th} fraction in the TREF distribution. The distributions have been normalized (the sum of the wᵢ equals 100%) with respect to the total area of the curve eluting above 30 degrees Celsius. Thus, the index reflects only the shape of the crystallized polymer. Any uncrystallized polymer (polymer still in solution at or below 30 degrees Celsius) is omitted from the calculation shown in Equation 1.

The unsaturated comonomers for P/E* copolymers include C₄₋₂₀ α-olefins, especially C₄₋₁₂ α-olefins such as 1-butene, 1-pentene, 1-hexene, 4-methyl-1-pentene, 1-heptene, 1-octene, 1-decene, 1-dodecene and the like; C₄₋₂₀ diolefins, preferably 1,3-butadiene, 1,3-pentadiene, norbornadiene, 5-ethylidene-2-norbornene (ENB) and dicyclopentadiene; C₈₋₄₀ vinyl aromatic compounds including sytrene, o-, m-, and p-methylstyrene, divinylbenzene, vinylbiphenyl, vinylnaphthalene; and halogen-substituted C₈₋₄₀ vinyl aromatic compounds such as chlorostyrene and fluorostyrene. Ethylene and the C₄₋₁₂ α-olefins are preferred comonomers, and ethylene is an especially preferred comonomer.

P/E* copolymers are a unique subset of P/E copolymers. P/E copolymers include all copolymers of propylene and an unsaturated comonomer, not just P/E* copolymers. P/E copolymers other than P/E* copolymers include metallocene-catalyzed copolymers, constrained geometry catalyst catalyzed copolymers, and Z-N-catalyzed copolymers. For purposes of this invention, P/E copolymers comprise 50 weight percent or more propylene while EP (ethylene-propylene) copolymers comprise 51 weight percent or more ethylene. As here used, “comprise . . . propylene”, “comprise . . . ethylene” and similar terms mean that the polymer comprises units derived from propylene, ethylene or the like as opposed to the compounds themselves.

“Propylene homopolymer” and similar terms mean a polymer consisting solely or essentially all of units derived from propylene. “Polypropylene copolymer” and similar terms mean a polymer comprising units derived from propylene and ethylene and/or one or more unsaturated comonomers.

“Relaxation Spectra Index (RSI),” as used herein, means a measure of the breadth of the relaxation time spectrum as determined by oscillatory melt rheometry using a Reologica ViscoTech controlled stress rheometer equipped with 20 mm diameter parallel plates. The instrument was operated at 180 degrees Celsius under a nitrogen atmosphere with a gap of 1.5 mm over frequencies (ω)) 0.01<ω<30 Hz. Stress sweeps were used to ensure that data were acquired within the linear viscoelastic regime. A Maxwell series model was fitted to the measured storage and loss modulii (G′,G″) to generate relaxation spectra and the ratio of the spectrum distribution moments (RSI) using a least-squares regression algorithm. The resulting rheology-modified polymer will have an RSI greater than that of the free-radical, chain-scissionable polymer (the unmodified base polymer). Preferably, the resulting rheology-modified polymer will have an RSI greater than 9, more preferably greater than 10, and most preferably greater than 11.

“Rheology Modified,” as used herein, means change in melt viscosity of a polymer as determined by dynamic mechanical spectroscopy (DMS). The change of melt viscosity is evaluated for high shear viscosity measured at a shear of 100 rad/sec and for low shear viscosity measured at a shear of 0.1 rad/sec.

The rheology-modified polymer preferably achieves a GN-300 less than or equal to its free-radical, chain-scissionable polymer. Also preferably, the rheology-modified polymer achieves a GN-600 less than or equal to its free-radical, chain-scissionable polymer. Also preferably, the rheology-modified polymer's GN is less than about 50 percent of its free-radical, chain-scissionable polymer.

Alternatively and also preferably, the rheology-modified polymer achieves a GN-300 less than 100 gels. More preferably, the rheology-modified polymer achieves a GN-300 less than 50 gels.

It should be apparent to the person of ordinary skill in the art that gel number “GN” in this context is distinct from and should not be confused with “weight percent gel” discussed elsewhere herein.

Alternatively and also preferably, the resulting rheology-modified polymer will have a gel content as measured by extraction in trichlorobenzene or decalin or xylene (ASTM 2765) of less than about 30 weight percent, preferably less than about 10 weight percent, and more preferably less than about 5 weight percent. Also preferably, the gel content of the rheology-modified polymer will be less than an absolute 5 weight percent greater than the gel content of the free-radical, chain-scissionable polymer (the unmodified polymer).

“Strain hardening,” as used herein and also called extension thickening, refers to a sudden increase of the extensional viscosity at strains high enough for molecules to become stretched and oppose a resistance to further deformation.

In its preferred embodiment, the present invention is a TAP-mediated, rheology-modified polymer being prepared in a reaction from a reaction mixture comprising (a) a free-radical, chain-scissionable organic polymer and (b) triallyl phosphate (TAP), wherein the TAP-mediated, rheology-modified polymer has an extensional viscosity at Hencky strains above one greater than that of the free-radical, chain-scissionable organic polymer and/or a Relaxation Spectra Index (RSI) greater than that of the free-radical, chain-scissionable organic polymer.

A variety of free-radical, chain-scissionable polymers can be rheology modified in the present invention. Suitable free-radical, chain-scissionable polymers include butyl rubber, polyacrylate rubber, polyisobutene, propylene homopolymers, propylene copolymers, styrene/butadiene/styrene block copolymers, styrene/ethylene/butadiene/styrene copolymers, polymers of vinyl aromatic monomers, vinyl chloride polymers, and blends thereof.

Preferably, the free-radical degradable, hydrocarbon-based polymer is selected from the group consisting of isobutene, propylene, and styrene polymers.

Preferably, the butyl rubber of the present invention is a copolymer of isobutylene and isoprene. The isoprene is typically used in an amount between about 1.0 weight percent and about 3.0 weight percent.

Examples of propylene polymers useful in the present invention include propylene homopolymers and P/E copolymers. In particular, these propylene polymers include polypropylene elastomers. The propylene polymers can be made by any process and can be made by Ziegler-Natta, CGC, metallocene, and non-metallocene, metal-centered, heteroaryl ligand catalysis.

Useful propylene copolymers include random, block and graft copolymers. Exemplary propylene copolymers include Exxon-Mobil VISTAMAX, Mitsui TAFMER, and VERSIFY™ by The Dow Chemical Company. The density of these copolymers is typically at least about 0.850, preferably at least about 0.860 and more preferably at least about 0.865, grams per cubic centimeter (g/cm³).

These propylene polymers typically have a melt flow rate (MFR) of at least about 0.01, preferably at least about 0.05, and more preferably at least about 0.1. The maximum MFR typically does not exceed about 2,000, preferably it does not exceed about 1000, more preferably it does not exceed about 500, further more preferably it does not exceed about 80 and most preferably it does not exceed about 50. MFR for copolymers of propylene and ethylene and/or one or more C₄-C₂₀ α-olefins is measured according to ASTM D-1238, condition L (2.16 kg, 230 degrees Celsius).

Styrene/butadiene/styrene block copolymers useful in the present invention are a phase-separated system. Styrene/ethylene/butadiene/styrene copolymers are also useful in the present invention.

Polymers of vinyl aromatic monomers are useful in the present invention. Suitable vinyl aromatic monomers include, but are not limited to, those vinyl aromatic monomers known for use in polymerization processes, such as those described in U.S. Pat. Nos. 4,666,987; 4,572,819 and 4,585,825.

Preferably, the monomer is of the formula:

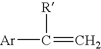

wherein R′ is hydrogen or an alkyl radical containing three carbons or less, Ar is an aromatic ring structure having from 1 to 3 aromatic rings with or without alkyl, halo, or haloalkyl substitution, wherein any alkyl group contains 1 to 6 carbon atoms and haloalkyl refers to a halo substituted alkyl group. Preferably, Ar is phenyl or alkylphenyl, wherein alkylphenyl refers to an alkyl substituted phenyl group, with phenyl being most preferred. Typical vinyl aromatic monomers which can be used include: styrene, alpha-methylstyrene, all isomers of vinyl toluene, especially para-vinyltoluene, all isomers of ethyl styrene, propyl styrene, vinyl biphenyl, vinyl naphthalene, vinyl anthracene and the like, and mixtures thereof.

The vinyl aromatic monomers may also be combined with other copolymerizable monomers. Examples of such monomers include, but are not limited to acrylic monomers such as acrylonitrile, methacrylonitrile, methacrylic acid, methyl methacrylate, acrylic acid, and methyl acrylate; maleimide, phenylmaleimide, and maleic anhydride. In addition, the polymerization may be conducted in the presence of predissolved elastomer to prepare impact modified, or grafted rubber containing products, examples of which are described in U.S. Pat. Nos. 3,123,655, 3,346,520, 3,639,522, and 4,409,369.

The present invention is also applicable to the rigid, matrix or continuous phase polymer of rubber-modified monovinylidene aromatic polymer compositions.

The reaction mixture from which the TAP-mediated, rheology-modified polymer is prepared can also contain non-scissionable polymers. A particularly useful scissionable organic polymer and non-scissionable polymer blend would be polypropylene and polyethylene.

For use in the present invention, the triallyl phosphate (TAP) would preferably be present in amount the range from about 0.05 weight percent to about 20.0 weight percent. More preferably, the coagent would be present in amount between about 0.1 weight percent and about 10.0 weight percent. Even more preferably, the coagent would be present in amount between about 0.3 weight percent and about 5.0 weight percent.

The free-radicals for use in the present invention may be formed in a variety ways. For example, oxygen-centered free radicals may occur through the use of organic peroxides, Azo free radical initiators, bicumene, oxygen, and air. In this regard, the reaction mixture may further comprise an organic peroxide, an Azo free radical initiator, bicumene, oxygen, or air. When an organic peroxide is used, the organic peroxide is generally present in an amount between about 0.005 weight percent and about 20.0 weight percent, more preferably, between about 0.01 weight percent and about 10.0 weight percent, and even more preferably, between about 0.03 weight percent and about 5.0 weight percent. For example, carbon-centered free radicals may occur through alkoxy radical fragmentation, allyl coagent activation, and chain-transfer to the free-radical reactive polymer.

In addition to or as alternative to using an additive to form free radicals, the polymer can form free radicals when subjected to shear energy, heat, or radiation. Accordingly, shear energy, heat, or radiation can act as free-radical inducing agent.

It is believed that when the free-radicals are generated by an organic peroxide, oxygen, air, shear energy, heat, or radiation, the combination of the triallyl phosphate and the source of free-radical is required for coupling of the polymer. Control of this combination determines the molecular architecture of the coupled polymer (that is, the rheology-modified polymer). Sequential addition of the triallyl phosphate followed by gradual initiation of free radicals provides a degree of control over the molecular architecture.

It is also believed that grafting sites can be initiated on the polymer and capped with the triallyl phosphate to form a pendantly-grafted structure. Later, the pendantly-grafted structure can couple with a subsequently formed free radical, imparting desired levels of homogeneity to the resulting rheology-modified polymer. The subsequently-formed free radical can be from an additional quantity of free-radical, chain-scissionable organic polymer or one or more other free-radical, chain-scissionable polymers.

In yet another embodiment, the present invention is a process for preparing TAP-mediated, rheology-modified polymers from free-radical, chain-scissionable organic polymers.

In a preferred embodiment, the present invention is an article of manufacture prepared from the rheology-modifiable polymer composition. Any number of processes can be used to prepare the articles of manufacture. Specifically useful processes include injection molding, extrusion, compression molding, rotational molding, thermoforming, blowmolding, powder coating, Banbury batch mixers, fiber spinning, and calendaring.

Suitable articles of manufacture include wire-and-cable insulations, wire-and-cable semiconductive articles, wire-and-cable coatings and jackets, cable accessories, shoe soles, multicomponent shoe soles (including polymers of different densities and type), weather stripping, gaskets, profiles, durable goods, rigid ultradrawn tape, run flat tire inserts, construction panels, composites (e.g., wood composites), pipes, foams, blown films, and fibers (including binder fibers and elastic fibers).

Foam products include, for example, extruded thermoplastic polymer foam, extruded polymer strand foam, expandable thermoplastic foam beads, expanded thermoplastic foam beads, expanded and fused thermoplastic foam beads, and various types of crosslinked foams. The foam products may take any known physical configuration, such as sheet, round, strand geometry, rod, solid plank, laminated plank, coalesced strand plank, profiles, and bun stock.

Foams made from a rheology-modified propylene polymer of the present invention are particularly useful. An example is a foam comprising a rheology-modified propylene copolymer comprising at least 50 weight percent of units derived from propylene, based on the total propylene copolymer, and units derived from ethylene, acrylate, vinyl acetate, or combinations thereof. Preferably, comonomer units are derived from ethylenically unsaturated comonomers, and the copolymer will have a melt flow rate in the range of from 0.5 to 8 g/10 min (ASTM 1238, 230° C., 2.16 kg load) and a Rheotens melt strength of at least 5 centiNewtons. The exemplified foam can further have a density of 800 kg/m³ or less.

### EXAMPLES

The following non-limiting examples illustrate the invention.

### Comparative Examples 1-8 and Examples 9 and 10

For the examples, an experimental reactor isotactic homopolymer polypropylene powder (i-PP) made by The Dow Chemical Company was used. The properties of this resin were as follows: Melt Flow Rate (MFR) of 3.14 g/10 min; DSC Melting Point of 167.1 degrees Celsius; and Bulk Density of 0.47 g/cc.

Table 1 shows the amounts of the coagents and Luperox 130 peroxide (L130) used for Comparative Examples 1-8 and Examples 9 and 10, where all amount are listed in weight percents. For brevity, the coagents are identified by the following abbreviations: triallylphosphate (TAP), trimethylolpropane triacrylate (TMPTAc), and triallyl trimesate (TAM).

TABLE 1

| Example | Coagent | Coagent (wt %) | L130 (wt %) |
|---|---|---|---|
| C. E. 1 | none | | none |
| C. E. 2 | none | | 0.05 |
| C. E. 3 | none | | 0.20 |
| C. E. 4 | TMPTAc | 2.69 | 0.05 |
| C. E. 5 | TMPTAc | 2.69 | 0.20 |
| C. E. 6 | TAM | 3.0 | 0.05 |
| C. E. 7 | TAM | 3.0 | 0.20 |
| C. E. 8 | TAP | 0.99 | 0.05 |
| Ex. 9 | TAP | 1.98 | 0.05 |
| Ex. 10 | TAP | 1.98 | 0.20 |

The examples were prepared by coating i-PP (3 g) with a hexanes solution (8 ml) containing the desired quantity of L130 and/or coagent. The hexanes solvent was evaporated, and the resulting mixture was charged to the melt-sealed cavity of an Atlas Laboratory Mixing Molder (minimixer) at 200 degrees Celsius for 6 min. The compositions that came out of the minimixer were subsequently stabilized by pressing the polymer into thin sheets at 170 degrees Celsius and mixing with a masterbatch of calcium stearate (500 ppm), Irganox 1010™ tetrakismethylene(3,5-di-t-butyl-4-hydroxylhydrocinnamate)methane (available from Ciba Specialty Chemicals Inc.) (500 ppm) and Irgafos 168 tris(2,4-di-tert-butylphenyl)phosphite (1000 ppm) by repeated folding and pressing at 170 degrees Celsius.

The stabilized exemplified compositions were analyzed by oscillatory melt rheometry using a Reologica ViscoTech controlled stress rheometer equipped with 20 mm diameter parallel plates. The instrument was operated at 180 degrees Celsius under a nitrogen atmosphere with a gap of 1.5 mm over frequencies (ω) 0.01<ω<30 Hz. Stress sweeps were used to ensure that data were acquired within the linear viscoelastic regime. A Maxwell series model was fitted to the measured storage and loss modulii (G′,G″) to generate relaxation spectra and the ratio of the spectrum distribution moments (RSI) using a least-squares regression algorithm.

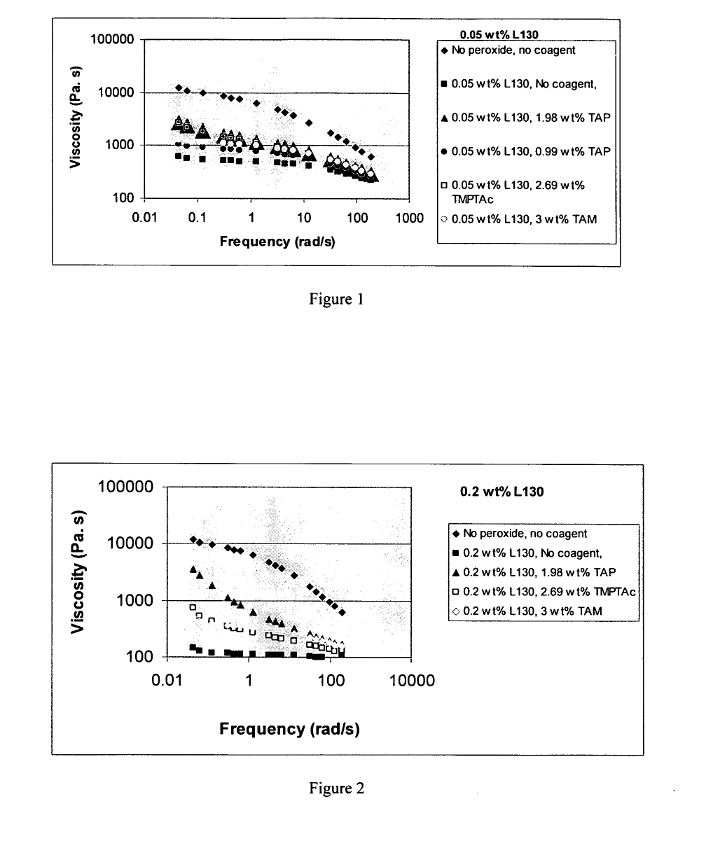

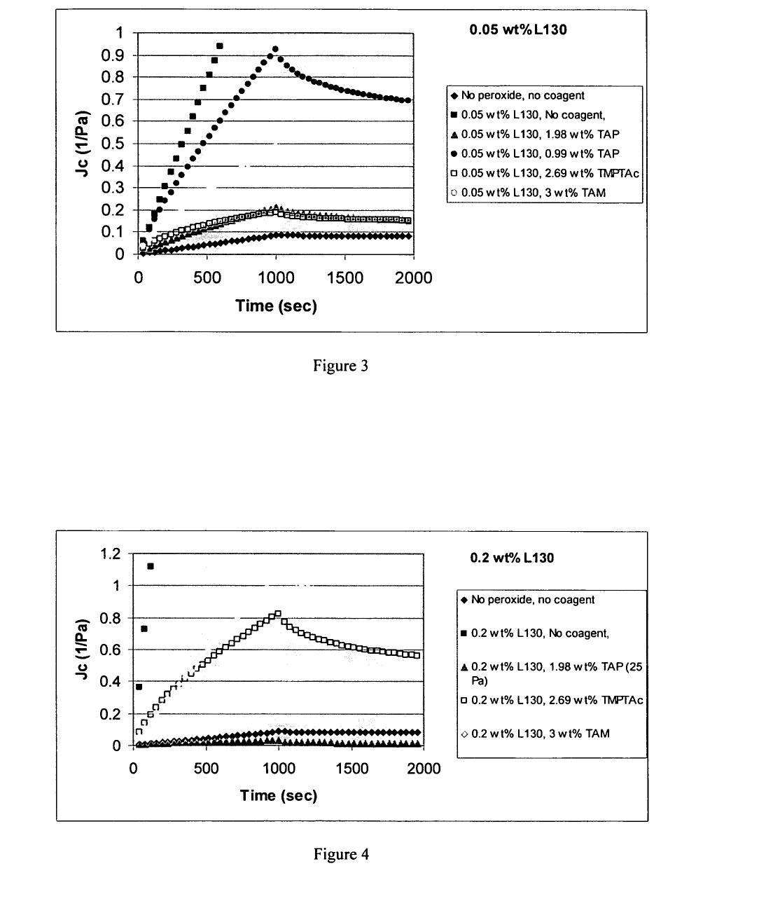

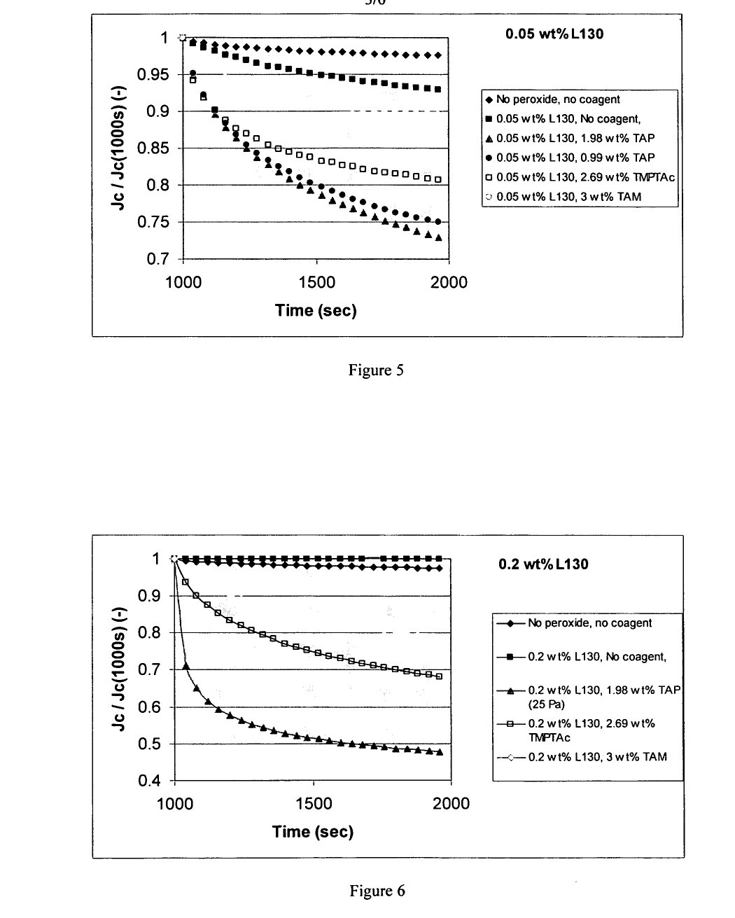

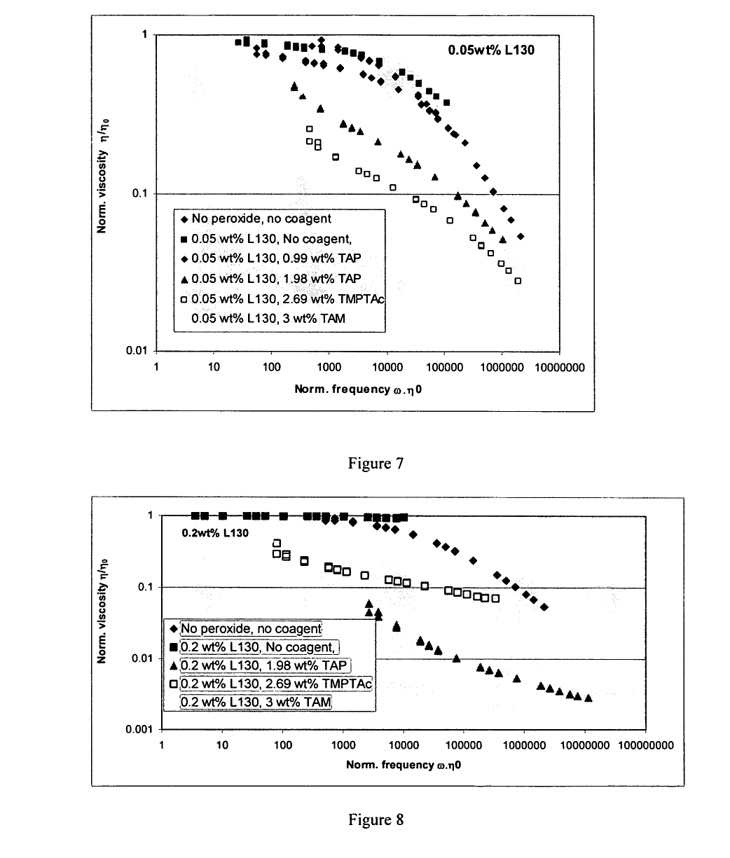

Creep experiments were also conducted on stabilized exemplified compositions using the aforementioned rheometer at 180 degrees Celsius (with 10 Pa load, unless otherwise indicated). The data were analyzed to calculate zero-shear viscosity and recoverable compliance. (The creep compliance recorded after 1000 s provides an estimate of the zero-shear viscosity, not the actual value.) The results are presented in FIGS. 1 to 8.

TABLE 2

| | Relaxation Spectra | Zero Shear Viscosity | Gel Content |
|---|---|---|---|
| Example | Index (RSI) | from Creep (Pa s) | (wt %) |
| C. E. 1 | 8.81 | 11520 | 0 |
| C. E. 2 | 1.83 | 603 | 0 |
| C. E. 3 | 1.08 | 816 | 0 |
| C. E. 4 | 2.81 | 10509 | 5 |
| C. E. 5 | 8.46 | 1809 | 3 |
| C. E. 6 | 4.78 | 2660 | 0 |
| C. E. 7 | 3.01 | 9620 | 0 |
| C. E. 8 | 2.46 | 1260 | 1 |
| Ex. 9 | 12.18 | 5540 | 4 |
| Ex. 10 | 39.45 | 60686 | 9 |

Extensional viscosity of the compositions was also measured.

The samples were prepared by unconstrained compression molding using 0.5 mm spacers and 10 tons pressure at a temperature of 350° F. for 15 minutes, and subsequently cut into strips of dimensions 20 mm long and 6 mm wide. A constant Hencky strain rate was applied and the time-dependent stress was determined from the measured torque and the sample time-dependent cross-section.

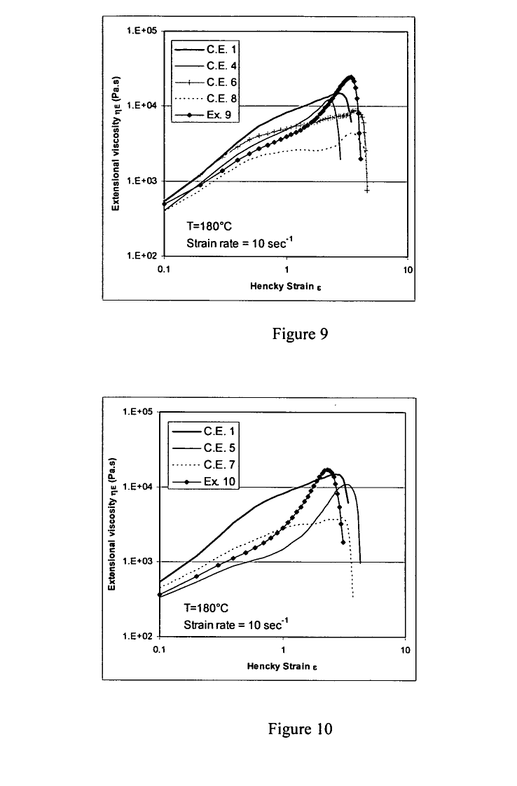

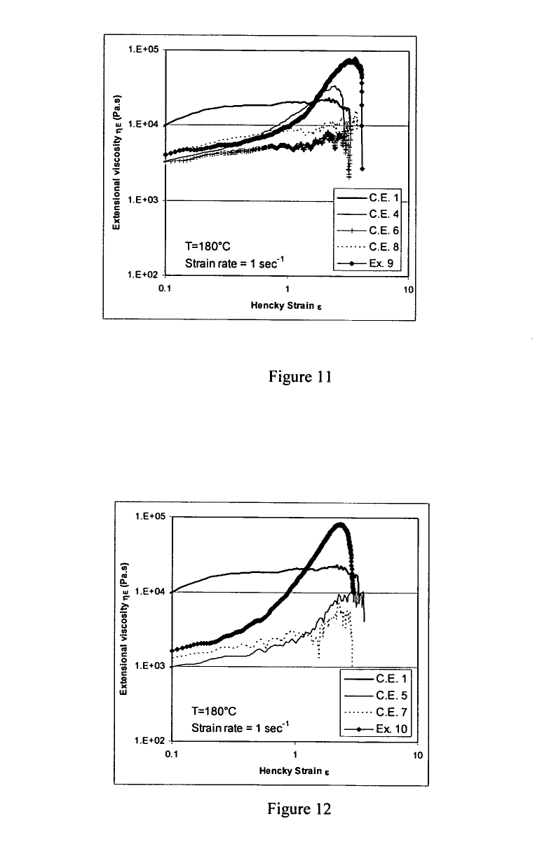

As shown in FIGS. 9-12, Ex. 9 and Ex. 10 demonstrated extensional viscosities at strains above ε=1 that were dramatically increased (relative to the comparative examples). At the same peroxide loading, TAP resulted in the maximum degree of strain hardening and yielded the maximum extensional viscosity at the peak before the samples eventually broke. Drawability was not sacrificed.

In contrast, the free-radical, chain-scissionable polypropylene before modification (C.E.1) did not show any sign of strain hardening, and the other coagents (C.E. 4, C.E. 5, C.E. 6, and C.E. 7) exhibited significantly inferior strain hardening.

What is claimed:

1. A triallyl phosphate-mediated, rheology-modified polymer prepared from a reaction mixture comprising:
(a) a free-radical, chain-scissionable organic polymer, and
(b) triallyl phosphate,
wherein the triallyl phosphate-mediated, rheology-modified polymer has a Relaxation Spectra Index (RSI) greater than that of the free-radical, chain-scissionable organic polymer.

2. The triallyl phosphate-mediated, rheology-modified polymer according to claim 1 wherein the reaction mixture further comprises a non-scissionable polymer.

3. The triallyl phosphate-mediated, rheology-modified polymer according to claim 1 wherein the triallyl phosphate-mediated, rheology-modified polymer includes no more than 10 weight percent gel.

4. The triallyl phosphate-mediated, rheology-modified polymer according to claim 1 wherein the triallyl phosphate-mediated, rheology-modified polymer includes no more than 5 weight percent gel.

5. A triallyl phosphate-mediated, rheology-modified polymer prepared from a reaction mixture comprising:
(a) a first quantity of a first free-radical, chain-scissionable organic polymer, wherein the polymer is pendantly-grafted with triallyl phosphate, and
(b) a second quantity of said first free-radical, chain-scissionable organic polymer or a quantity of a second free-radical chain-scissionable organic polymer,
wherein the triallyl phosphate-mediated, rheology-modified polymer has a Relaxation Spectra Index (RSI) greater than that of the first free-radical, chain-scissionable organic polymer.

6. The triallyl phosphate-mediated, rheology-modified polymer according to claim 5 wherein the triallyl phosphate-mediated, rheology-modified polymer includes no more than 10 weight percent gel.

7. The triallyl phosphate-mediated, rheology-modified polymer according to claim 5 wherein the triallyl phosphate-mediated, rheology-modified polymer includes no more than 5 weight percent gel.

8. A process for preparing a triallyl phosphate-mediated, rheology-modified polymer comprising the step of reacting:
(a) a free-radical, chain-scissionable organic polymer, and
(b) triallyl phosphate,
wherein the triallyl phosphate-mediated, rheology-modified polymer has a Relaxation Spectra Index (RSI) greater than that of the free-radical, chain-scissionable organic polymer.

9. The process according to claim 8 wherein the triallyl phosphate-mediated, rheology-modified polymer includes no more than 10 weight percent gel.

10. The process according to claim 8 wherein the triallyl phosphate-mediated, rheology-modified polymer includes no more than 5 weight percent gel.

11. An article of manufacture prepared from a triallyl phosphate-mediated, rheology-modified polymer according to claim 1.

12. The article of manufacture according to claim 11 wherein the article is a foam.

13. The article of manufacture according to claim 12 wherein the free-radical, chain-scissionable organic polymer is a propylene copolymer comprising at least 50 weight percent of units derived from propylene, based on the total propylene copolymer, and units derived from unsaturated monomers.

14. The article of manufacture according to claim 13 wherein the unsaturated monomers are selected from the group consisting of ethylene, acrylate, vinyl acetate and combinations thereof.

15. An article of manufacture according to claim 11 wherein the propylene copolymer has a melt flow rate in the range of from about 0.5 grams per 10 minutes to about 8 grams per 10 minutes and a Rheotens melt strength of at least about 5 centiNewtons.

16. A triallyl phosphate-mediated, rheology-modified polymer prepared from a reaction mixture comprising:
(a) a free-radical, chain-scissionable organic polymer, and
(b) triallyl phosphate,
wherein the triallyl phosphate-mediated, rheology-modified polymer has extensional viscosity at Hencky strains above one greater than that of the free-radical, chain-scissionable organic polymer.

17. A triallyl phosphate-mediated, rheology-modified polymer prepared from a reaction mixture comprising:
(a) a first quantity of a first free-radical, chain-scissionable organic polymer, wherein the polymer is pendantly-grafted with triallyl phosphate, and
(b) a second quantity of said first free-radical, chain-scissionable organic polymer or a quantity of a second free-radical chain-scissionable organic polymer,
wherein the triallyl phosphate-mediated, rheology-modified polymer has extensional viscosity at Hencky strains above one greater than that of the first free-radical, chain-scissionable organic polymer.

18. A process for preparing a triallyl phosphate-mediated, rheology-modified polymer comprising the step of reacting:
(a) a free-radical, chain-scissionable organic polymer, and
(b) triallyl phosphate,
wherein the triallyl phosphate-mediated, rheology-modified polymer has extensional viscosity at Hencky strains above one greater than that of the free-radical, chain-scissionable organic polymer.

19. An article of manufacture prepared from a triallyl phosphate-mediated, rheology-modified polymer according to claim 16.

20. An article of manufacture according to claim 19 wherein the article is a wire/cable.
